(19) United States
(12) Patent Application Publication
(10) Pub. No.: US 2026/0202506 A1
(43) Pub. Date: Jul. 16, 2026

(54) ELECTRONIC DEVICE FOR MULTI-BEAM APPLICATIONS AND METHOD OF OPERATING AN ELECTRONIC DEVICE FOR MULTI-BEAM APPLICATIONS

(71) Applicant: ETH ZURICH, Zürich (CH)

(72) Inventors: Hua WANG, Erlenbach (CH); Basem Abdelaziz ABDELMAGID, Zürich (CH); Kyungsik CHOI, Zürich (CH)

(21) Appl. No.: 19/134,583

(22) PCT Filed: Nov. 30, 2023
(86) PCT No.: PCT/EP2023/083795

§ 371 Date: May 30, 2025

(30) Foreign Application Priority Data
Dec. 2, 2022 (CH) CH001449/2022

(51) Int. Cl. G01S 7/03

(52) U.S. Cl. CPC G01S 7/03

(57) ABSTRACT

An electronic device (1) comprises a time-modulated receiver array (RX) or a beamforming network (BFN) connected with a time-modulated transmitter array (TX), wherein the time-modulated transmitter array (TX) includes a plurality of switches (ST1, . . . , STN) which are periodically operable between an on state (1) and an 5 off state (0) for periodic signal transmission to a plurality of antenna elements (AT1, . . . , ATN).

### FIELD OF THE INVENTION

The present invention relates to an electronic device for multi-beam applications and a method of operating an electronic device for multi-beam applications.

### BACKGROUND ART

Full-duplex and MIMO techniques using time-modulation array for communication and sensing.

Full-duplex and multiple-input-multiple-output (MIMO) communication are two emerging wireless technologies that have attracted wide attentions in recent years. Full duplex communication allows the same radio to transmit and receive at the same time, the same frequency, and with the same wave polarization, which directly doubles the spectral efficiency of the communication link. Moreover, full duplex systems are essential for any monostatic radars, imagers, interferometers, and spectrometers. On the other hand, MIMO technologies, especially concurrent multi-beam MIMOs, allows sharing one of the channel resources (e.g., frequency or space) to establish simultaneous communication between a number of users. It should be noted that MIMOs and phased arrays have become necessity for mm-Wave/sub-mm-Wave/THz wireless communication and sensing, including automotive radars (Infineon, TI, NXP), gesture sensing radars (Google Soli, Apple iPhone), 5G mobile phones (Apple iPhone and Samsung Galaxy and Note), 5G base stations/CPEs, mm-Wave backhauls, and satellite communications (LEO satellite networks by SpaceX, One Web, and Amazon/Kuiper).

Achieving the functionalities of full-duplex communication or concurrent multi-beam MIMO communication is still a great challenge in the wireless technology field. For the full-duplex technology, the most significant challenge arises from the fact that the full-duplex functionality should be achieved without degrading the performance of the radio's transmitter and receiver, and without having significant self-interference from the transmitter to the receiver of the same radio when they work simultaneously at the same frequency. On the other hand, the MIMO technology should be carried out such that each communication process is negligibly affected by other communication processes. Moreover, full-duplex MIMOs, which aim at leveraging the advantages of the two, will entail even more challenges, such as inter-element transmitter-receiver feedthroughs.

A. Nagulu, et al., “6.6 Full-Duplex Receiver with Wideband Multi-Domain FIR Cancellation Based on Stacked-Capacitor, N-Path Switched-Capacitor Delay Lines Achieving >54 dB SIC Across 80 MHz BW and >15 dBm TX Power-Handling,” 2021 IEEE International Solid-State Circuits Conference (ISSCC), 2021, pp. 100-102. A. Nagulu, et al. achieves full-duplex functionality with sophisticated circuitry to reduce the transmitter-receiver interference.

E. Naviasky, et al., “A 71-to-86-GHz 16-Element by 16-beam Multi-User Beamforming Integrated Receiver Sub-Array for Massive MIMO,” IEEE Journal of Solid-State Circuits, vol. 56, no. 12, pp. 3811-3826, December 2021. E. Naviasky, et al. provides a means to achieve the MIMO capability relying on sophisticated digital signal processing.

Concurrent multi-beam beamformers for MIMO radar/sensing and communication applications.

Millimeter-wave (mm-wave) radar systems have been gaining traction in many sensing applications such as contactless vital detection, gesture recognition, unmanned aerial vehicles (UAV), and so on as they allow taking advantage of compact form factor and enhanced range resolution. At the same time, mm-Wave wireless communication is gaining increasing tractions with the growing deployment of mm-Wave 5G systems and heavy investment on sub-mm-Wave 6G wireless.

While phased arrays and MIMO systems are widely used in these mm-Wave communication/sensing systems to compensate for the propagation loss, the resulting highly directional beams lead to various new challenges, including transmitter-receiver localization, beam-alignment/-tracking, beam-scanning for radar/imaging, which require sweeping the array beams over the entire field-of-view (FoV). In practice, this limits the sensing speed in radar/imaging systems and latency to establish links in communication. Note that these limitations will severely constrain the functionalities of these mm-Wave systems for applications that require ultra-low latency (automotives, advanced manufacturing, AR/VR), high reliability, and operations in dynamic, mobile, and fast-changing environments (satellite-on-the-move, drones, and mobile phones).

With joint communication and sensing as a key focus of the next-generation wireless evolution, multi-input multi-output (MIMO) systems are becoming essential in future wireless networks. In particular, concurrent multi-beam MIMOs, besides enhancing channel capacities and link quality, can enable rapid localization and situational awareness sensing to create new use cases. To perform beam forming and steering, analog beamforming arrays utilize element-level phase shifters and power combining/splitting networks, while digital beamforming arrays rely on the digital backend for beam syntheses. To process N-beam, analog beamformers for concurrent multi-beam MIMO require N-independent beamformers, substantially complicating systems in terms of power, area, and cost. Digital beamforming arrays perform beam-space computation in the digital backend for highly scalable concurrent multi-beam syntheses, but they require powerful digital backends and one complete RF analog-ADC/DAC signal chain for each channel, limiting their use in resource-constrained low-cost/low-power applications. Note the limitations of these existing beamforming architectures are fundamentally due to their static array nature, i.e., time-invariant array configurations during the beam operation.

With the increasing need for data-rate and channel throughput, the mm-Wave and sub-terahertz (sub-THz) spectrums have been actively explored for the next generation 6G wireless communication. While utilizing pencil-sharp beams can overcome severe path loss, these high-frequency links are highly susceptible to blockage and mostly limited to line-of-sight (LOS) channels. To enhance their reliability in dynamic channels, relays and reflective surfaces can create non-line-of-sight (NLOS) paths between the original transmitter (TX) and the target receiver (RX). A growing number of passive and active relays at mm-Wave/sub-THz are reported. However, most of these relays [2-4] only establish a single communication link between one pair of TX/RX users. Recently, a 28 GHz multi-beam and decentralized active relay array is reported, which transmits three independent data streams. However, these streams must come from a single TX user as a single frequency-multiplexed beam, and the relay cannot concurrently receive multiple beams from different spatial users. Furthermore, the data is processed at an intermediate frequency (IF). This requires a pair of down-/up-conversion mixers and a local-oscillator (LO) signal for every element, complicating the array scalability over frequency or array size.

Sadhu, Bodhisatwa, et al. “A 28-GHz 32-element TRX phased-array IC with concurrent dual-polarized operation and orthogonal phase and gain control for 5G communications.” IEEE Journal of Solid-State Circuits 52.12 (2017):3373-3391. In Sadhu, Bodhisatwa, et al., the concurrent multi-beam is generated by dividing the whole antenna array into several sub-arrays (1×M) where each sub-array creates a single-beam.

### DISCLOSURE OF THE INVENTION

There may be a need for an improved electronic device for multi-beam applications and a method of operating an electronic device for multi-beam applications. In particular there may be a need for an improved electronic device for multi-beam applications and a method of operating an electronic device for multi-beam applications with improved transmitting, receiving, notching, filtering, and/or processing operations. In particular there may be a need for an improved electronic device for multi-beam applications and a method of operating an electronic device for multi-beam applications enabling an active relay. In particular there may be a need for an improved electronic device for multi-beam applications and a method of operating an electronic device for multi-beam applications enabling communication, half-duplex communication, or full-duplex communication. In particular there may be a need for an improved electronic device for multi-beam applications and a method of operating an electronic device for multi-beam applications enabling radar, imaging, and/or sensing. In particular there may be a need for an improved electronic device for multi-beam applications and a method of operating an electronic device for multi-beam applications enabling beam multiplication.

Such a need may be met with the subject-matter of the independent claims. Advantageous embodiments are defined in the dependent claims.

Ideas underlying embodiments of the present invention may be interpreted as being based, inter alia, on the following observations and recognitions.

The invention is set out in the appended set of claims.

An aspect of the invention relates to an electronic device which comprises a time-modulated receiver array or a beamforming network connected with a time-modulated transmitter array, wherein the time-modulated transmitter array includes a plurality of switches which are periodically operable between an on state and an off state for periodic signal transmission to a plurality of antenna elements. The electronic device has improved transmitting, receiving, notching, filtering, and/or processing operations.

In some embodiments, the switches of the time-modulated transmitter array are operable in an non-overlapping mode.

In some embodiments, a power splitter of the time-modulated transmitter array is connected to a power combiner of the time-modulated receiver array. An active relay is enabled.

In some embodiments, antenna elements are shared by the time-modulated receiver array and the time-modulated transmitter array.

In some embodiments, switches of the time-modulated receiver array and switches of the time-modulated transmitter array are operable in a time-interleaved mode. Full-duplex communication is enabled.

In some embodiments, the beamforming network includes one or more of a passive beamformer, an active beamformer, a Butler matrix, a Rotman Lens, a phase-shifter based beamformer, an analog beamformer, a digital beamformer, and a hybrid beamformer.

In some embodiments, the time-modulated transmitter array includes one or more of an amplitude modulation circuit and a phase modulation circuit.

In some embodiments, one or more switches is operable in a signal path or in a biasing path. Enhanced performance can be achieved.

In some embodiments, one or more switches is further connected to a phase shifter. Beam-steering is improved.

In some embodiments, the electronic device is operable at a 0/180 switching scheme or a multiphase switching scheme such as 0/90/180/270.

The invention is further related to a radar system comprising an electronic device as described.

The invention is further related to a method of operating an electronic device as described, wherein the switches are periodically operated between an on state and an off state for periodic signal transmission to the plurality of antenna elements.

In some embodiments, the switches of the time-modulated transmitter array are operated in an non-overlapping mode.

In some embodiments, the electronic device is operated for sharing antenna elements between the time-modulated receiver array and the time-modulated transmitter array.

In some embodiments, switches are operated in a time-interleaved mode.

In some embodiments, one or more switches is operated in a signal path or in a biasing path.

In some embodiments, the electronic device is operated at a 0/180 switching scheme or a multiphase switching scheme such as 0/90/180/270.

### BRIEF DESCRIPTION OF THE DRAWINGS

In the following, advantageous embodiments of the invention will be described with reference to the enclosed drawings. However, neither the drawings nor the description shall be interpreted as limiting the invention.

FIG. 1 schematically shows an electronic device according to the present invention.

FIG. 2 shows a circuit diagram of an exemplary time-modulated receiver array.

FIG. 3 shows a circuit diagram of an exemplary time-modulated transmitter array TX.

FIG. 4 shows a circuit diagram of an exemplary electronic device according to the present invention enabling an active relay.

FIG. 5 shows a behavioral modeling of an 8-element time-modulated linear-periodically-time-varying (LPTV) multiple-input-multiple-output (MIMO) relay based on the architecture illustrated in FIG. 4.

FIG. 6 shows on-chip antennas with their simulation results.

FIG. 7 shows a 3-stage frontend amplifier with capacitively neutralized common-source stages and transformer matching networks.

FIG. 8 shows that compared with state-of-the art relays, a time-modulated active relay according to the present invention achieves a competitive performance at high mm-wave frequency.

FIG. 9 shows a circuit diagram of an exemplary electronic device 1 according to the present invention enabling full-duplex communication.

FIG. 10 shows a circuit diagram of an exemplary beamforming network.

FIG. 11 shows a circuit diagram of an exemplary time-modulated transmitter array.

FIG. 12 shows a circuit diagram of an exemplary electronic device according to the present invention enabling beam multiplication.

FIG. 13 shows a circuit diagram of an exemplary electronic device according to the present invention.

FIG. 14 shows an amplitude modulation scheme and a phase modulation scheme.

FIG. 15 shows clock scenarios for spatial distribution of concurrent 20 beams.

### MODE(S) FOR CARRYING OUT THE INVENTION

Traditional MIMOs or phased arrays mostly rely on amplitude and phase modulation on each array element, and the modulations are static settings during each beam operation, hence operating as static arrays. In contrast, the present invention proposes joint space-time-frequency modulation on each array element besides the amplitude/phase modulations. Moreover, the present invention focuses on the space-time-frequency-amplitude-phase modulations happening at similar or higher speed than the signal modulation speed, i.e., functioning as dynamic arrays.

Full-duplex and MIMO techniques using joint space-time-frequency modulation array for communication and sensing.

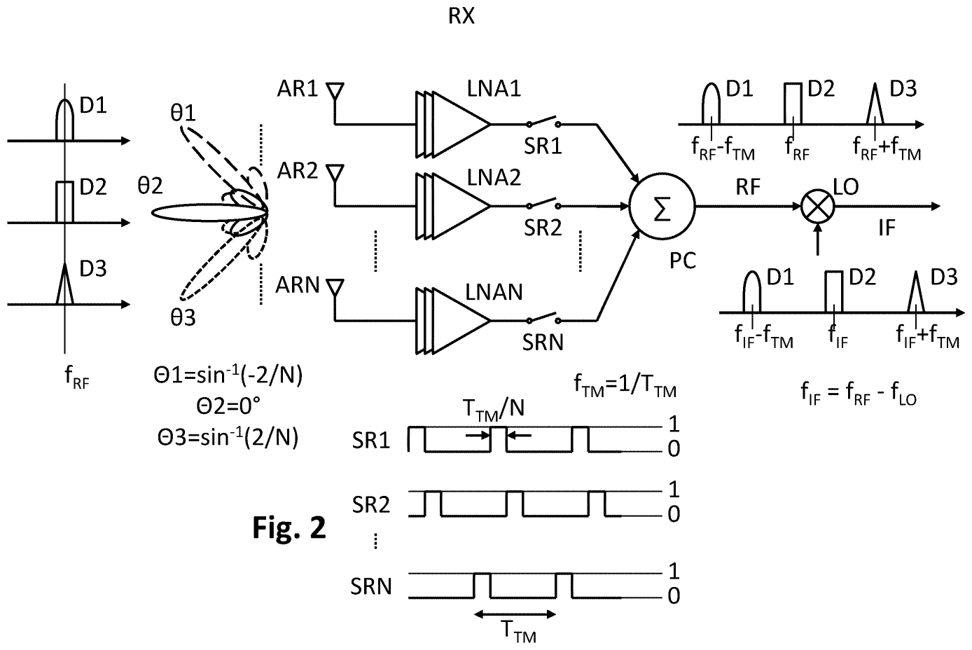

The present invention is based on using joint space-time-frequency modulation on the array elements at the transmitter arrays and/or the receiver arrays to achieve the MIMO capability, and to operate the transmitter and the receiver of the same radio in a time-interleaved fashion to achieve the full duplex capability. As shown in FIG. 2, the radio comprises a dynamic array of N transmitters, a dynamic array of N receivers, and N antennas. The array can be composed of co-apertured elements, namely each antenna being shared between one transmitter and one receiver in the same array element. Each dynamic array of the transmitters and receivers is operated with time-modulation, which essentially means that all or some of the array elements are turned on sequentially, so that each element is turned on for only a fraction of the time, which can be the same or different across the array elements. The time-modulation speed is chosen larger than the modulation bandwidth to satisfy the Nyquist criteria and preserve the signals fidelity.

In addition, the time modulation sequences of all the array elements or the adjacent array elements can be programmed, so that the co-element transmitters/receivers or adjacent-element transmitters/receivers or the whole array transmitters/receivers are turned on and off in a time-interleaving fashion. This achieves the full-duplex capability, while ensuring low or no coupling between transmitters and receivers, as transmitters and receivers in concern are not turned on at the same time. Accordingly, the co-element or adjacent-element transmitter-receiver interference issue in existing full-duplex radios can be largely mitigated, and the need for interference cancellation and the associated overhead, power consumption, and system complexity are eliminated.

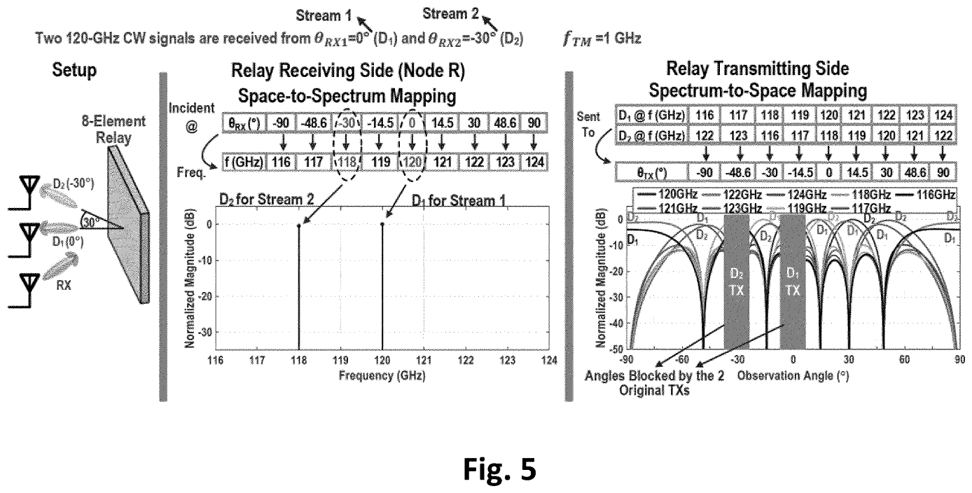

The full-duplex MIMO dynamic array according to the present invention is frequency agnostic and can be used in next-generation 5G/6G arrays, repeaters, and reconfigurable intelligent surfaces (RIS). As shown in FIG. 5, RIS is a key to enable non-line-of-sight (NLOS) communication to enhance the reliability, agility, and versatility of communication links. Besides serving as repeaters or NLOS links, RIS can also be constructed as transmitter arrays, receiver arrays, transmitter/receiver hybrid arrays, or full-duplex arrays for transmitting, receiving, or joint transmitting/receiving multiple signals.

Further, it should be added that a frequency modulation array can be added to this scheme as well, to achieve time-varying array patterns and result in super lateral resolution in radar scanning, imaging, transmitter/receiver localization with full duplex operations.

### Concurrent Multi-Beam Beamformer

Key innovation is to combine static beamformers and the dynamic beamformers to jointly form a large number of concurrent beams. The static beamformers can be passive or active. Example static beamformers include but are not limited to N-element Butler matrix, Rotman Lens, any phase-shifter based beamformers, and analog, digital or hybrid beamformers

As an example for dynamic beamformer, the N-element time-modulation array can be fully passive or active network and is capable of generating multi-beams (N+1 beams) concurrently. One or multiple dynamic beamformers and static beamformers can be cascaded to form a large number of simultaneous beams.

It should be further emphasized that such joint static-dynamic beamformers can be made completely bidirectional allowing its co-operation with full duplex operation or its practical implementation as ultra-compact bidirectional wireless frontend systems. Further, it should be added that frequency modulation array can be added to this scheme as well, to achieve time-varying array patterns and result in super lateral resolution in radar scanning, imaging, transmitter/receiver localization with concurrent multi-beams.

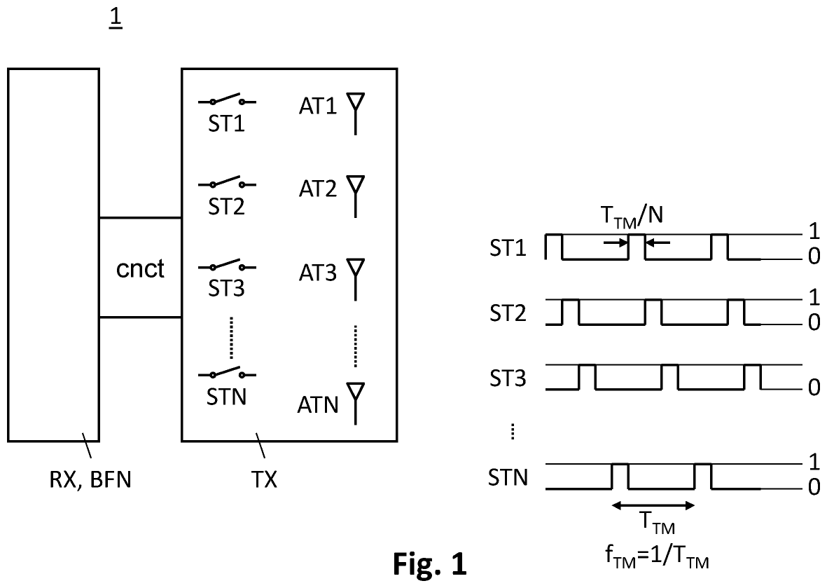

FIG. 1 schematically shows an electronic device 1 according to the present invention. A time-modulated receiver array RX or a beamforming network BFN connected cnct with a time-modulated transmitter array TX. The time-modulated transmitter array TX includes a plurality of switches ST1, . . . , STN which are periodically operable between an on state 1 and an off state 0 for periodic signal transmission to a plurality of antenna elements AT1, . . . , ATN.

FIG. 2 shows a circuit diagram of an exemplary time-modulated receiver array RX. The receiver array RX includes a number N of RX paths. Each RX path includes an antenna element ARn, which is connected to a low-noise amplifier LNAn, which is connected to a switch SRn, wherein n=1, . . . , N. The switches SR1, . . . , SRN are connected to a power combiner PC, which combines the signal received from the switches SR1, . . . , SRN and outputs a signal RF. A mixer/local oscillator LO receives the signal RF and outputs an intermediate frequency signal IF.

As shown in FIG. 2, the switches SR1, . . . , SRN are switched between on (indicated with state 1) and off (indicated with state 0, cf. timing diagram of FIG. 2). Namely, a first switch SR1 is turned on during a first period of time and the other switches are turned off, a second switch SR2 is turn on during a second period of time and the other switches are turned off, etc. Accordingly, the switches SR1, . . . , SRN enable time-modulation of the receiver array RX.

As shown in FIG. 2, the time-modulated receiver array RX can receive multiple signals D1, D2, D3, . . . having center frequency f_{RF}. The multiple signals D1, D2, D3, . . . —incident from different angles θ1, θ2, θ3, . . . in space-are concurrently received at the antenna elements AR1, . . . , ARN, mapped and frequency-multiplexed to signal RF, which includes the multiple signals D1, D2, D3, . . . at different frequencies f_{RF}±n f_{TM} (cf. FIG. 2), wherein T_{TM} is the on-duration for each RX path, and f_{TM}=1/T_{TM} is the time-modulation frequency, and n=0, ±1, ±2, . . . , ±N/2. Preferably, f_{TM} is sufficiently larger than the modulation bandwidth to ensure Nyquist sampling without inter-beam aliasing. As shown in FIG. 2, the mixer/local oscillator LO maps signal RF having frequency f_{RF} to an intermediate frequency signal IF having frequency f_{IF}=f_{RF}−f_{LO}, for example for further processing. The intermediate frequency signal IF includes the multiple signals D1, D2, D3, . . . at different frequencies f_{IF}±n f_{TM}.

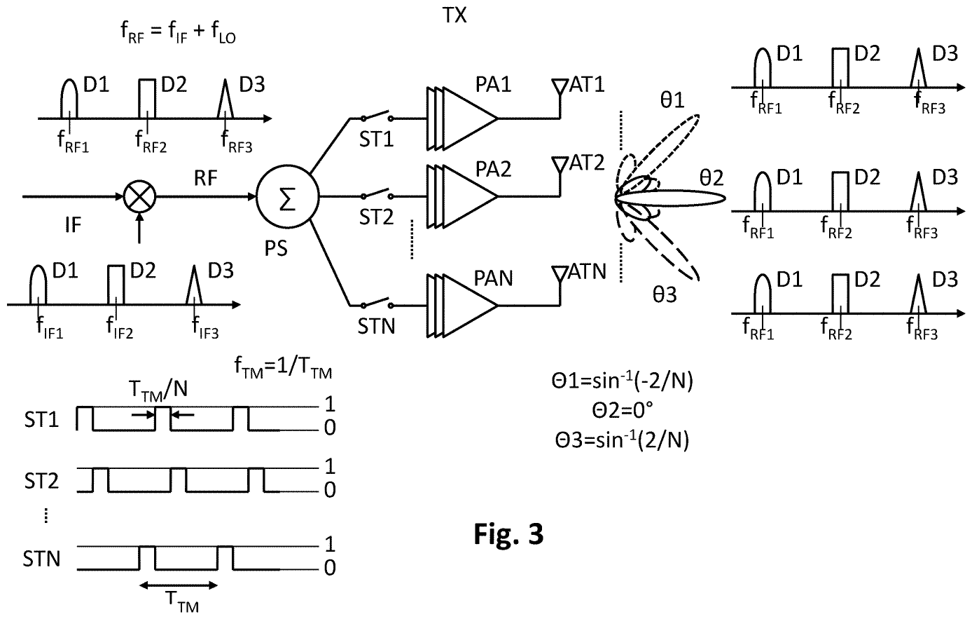

FIG. 3 shows a circuit diagram of an exemplary time-modulated transmitter array TX. A mixer/local oscillator LO maps intermediate frequency signal IF to signal RF. In particular, signals D1, D2, D3, . . . at intermediate frequencies f_{IF1}, f_{IF2}, f_{IF3} of the intermediate frequency signal IF are mapped to signals D1, D2, D3, . . . at frequencies F_{RFi}=f_{IFi}+f_{LO}, i=1, 2, 3, . . . of the signal RF.

As will be described in more detail below, according to the present invention, the mixers/local oscillators LO (cf. FIGS. 2, 3) can be missing.

As shown in FIG. 3, the signal RF is received by a power splitter PS, which splits the signal RF for transmission to N TX paths. Each TX path includes a switch STn, which is connected to a power amplifier PAn, which is connected to an antenna element ATn, wherein n=1, . . . , N.

As shown in FIG. 2, the switches ST1, . . . , STN are switched between on (indicated with state 1) and off (indicated with state 0, cf. timing diagram of FIG. 3). Namely, a first switch ST1 is turned on during a first period of time and the other switches are turned off, a second switch ST2 is turn on during a second period of time and the other switches are turned off, etc. Accordingly, the switches ST1, . . . , STN enable time-modulation of the transmitter array TX. These switches can be implemented in the biasing path of the amplifiers, instead of the signal path, to reduce the losses and enhance the noise performance, linearity performance, and/or efficiency performance.

While timing diagrams in the Figures show non-overlapping time-modulation, overlapping time-modulation is feasible in practice.

As shown in FIG. 3, the signal RF, which includes signals D1, D2, D3, . . . at frequencies f_{RF1}, f_{RF2}, f_{RF3}, . . . , is transmitted by the antenna elements AT1, . . . , ATN at different transmitting angles θn=sin⁻¹(2n/N), n=0, ±1, ±2, . . . , +N/2, into the space with preserved signal fidelity. For example, a user device at an angle θn can employ respective filter-banks to only pick-up signals D1, D2, D3, . . . of interest.

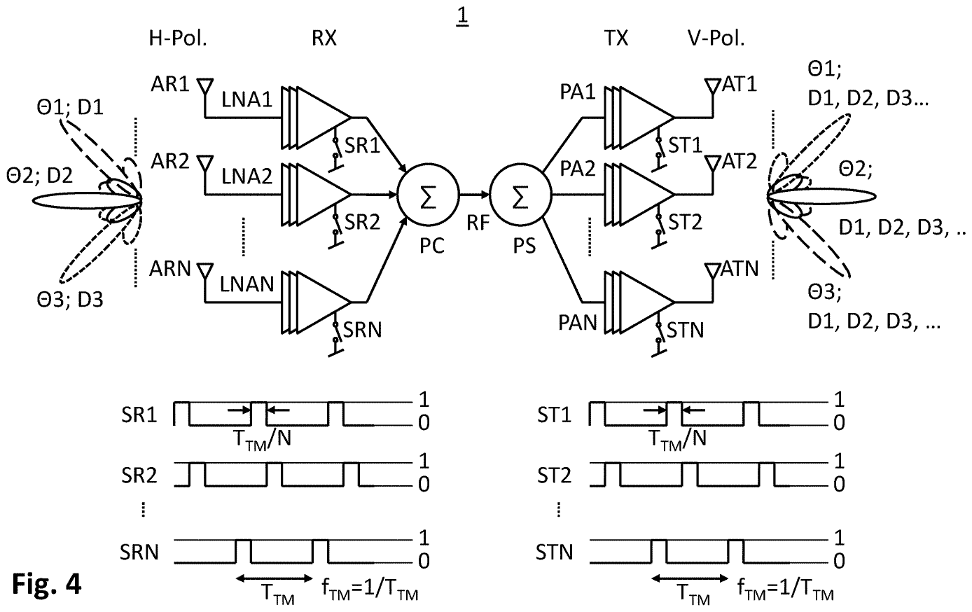

FIG. 4 shows a circuit diagram of an exemplary electronic device 1 according to the present invention enabling an active relay. A time-modulated transmitter array TX as described above is connected to a time-modulated receiver array RX as described above. In particular, the power combiner PC of the time-modulated transmitter array TX is connected to the power splitter PS of the time-modulated receiver array RX. The switches SR1, . . . , SRN of the time-modulated receiver array RX and the switches of the time-modulated transmitter array TX are operated as shown in FIG. 4. Note that there is no mixer/local oscillator arranged between the power combiner PC and the power splitter PS.

The time-modulated receiver array RX receives signals D1, D2, D3, . . . from different angles θ1, θ2, θ3, . . . in space. The time-modulated transmitter array TX transmits signals to different angels θ1, θ2, θ3, . . . in space, each including the signals D1, D2, D3, . . . . The number of receiver paths RX can differ from the number of transmitter paths TX. The reception and transmission angles can be further controlled by incorporating additional phase shifters in the RX/TX arrays and/or reprogramming the time-modulation sequences. Time-modulation sequences can be also reconfigured to program the number of concurrent beams at each of the RX/TX arrays from N+1 to 1. Multi-phase switching (e.g., 0°/180° operation or 0°/90°/180°/270° operation) can be also combined with time-modulation to enhance the array gain of a certain beam and/or suppress undesirable beams.

As shown in FIG. 4, the antenna elements AR1, . . . , ARN of the time-modulated receiver RX can have a different polarization (e.g. a horizontal polarization H-Pol.) than the antenna elements AT1, . . . , ATN of the time-modulated transmitter array TX (e.g. a vertical polarization V-Pol.), thereby suppressing or avoiding direct coupling between the RX array and the TX array.

Thus, signals D1, D2, D3, . . . of different user devices arranged on the side of the time-modulated receiver array RX can be relayed to different user devices arranged on the side of the time-modulated transmitter array TX. Accordingly, the electronic device shown in FIG. 4 enables a time-modulated active relay.

FIG. 5 shows a behavioral modeling of an 8-element time-modulated linear-periodically-time-varying (LPTV) multiple-input-multiple-output (MIMO) relay based on the architecture illustrated in FIG. 4. The behavior modeling demonstrates its functionality. Two 120 GHz continuous-wave (CW) signals are concurrently received from 0° (D1) and −30° (D2) as two independent streams. With f_{TM}=1 GHz, D1 and D2 are mapped at the RX array output to 120 GHz and 118 GHz respectively (signal RF). The TX array then broadcasts these two streams to various angles at different frequency components. End RX users can receive either or both of these two streams (D1 and D2), showing the robustness and diversity of the established non-line-of-sight (NLOS) links. Note the spatial angles of the RX/TX beams can be further controlled by incorporating additional phase shifters in the RX or TX arrays.

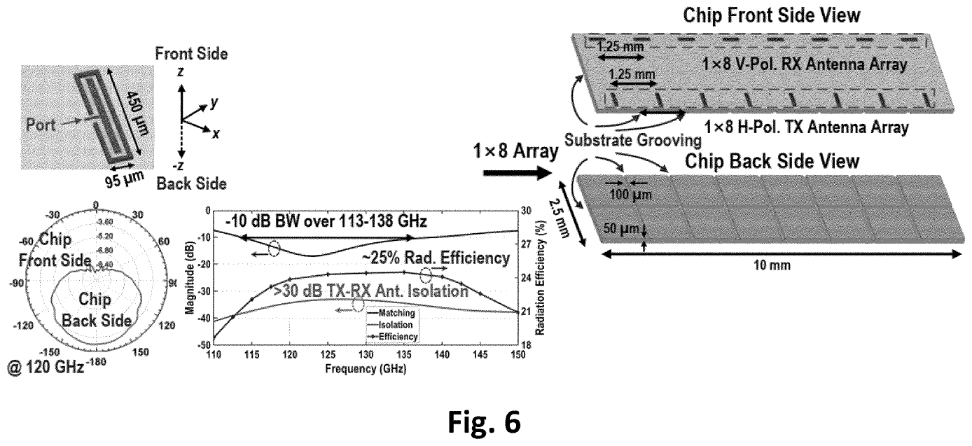

FIG. 6 shows on-chip antennas with their simulation results. The on-chip antennas are implemented as a folded-slot structure at 120-GHz. The RX antennas are rotated 90° with respect to the TX antennas, realizing orthogonal polarization to enhance TX/RX isolation. The antenna elements of the RX/TX arrays are placed on a λ/2 grid to eliminate grating lopes. They are designed for chip backside radiation, and substrate grooving is utilized to partially suppress the substrate modes and improve the radiation efficiency and isolation. Simulations show matching better than −10 dB across 113-138 GHz, worst-case isolation between TX and RX antennas >30 dB across the whole D-band, and radiation efficiency around 25% at 120 GHz. The unit antenna, at 120 GHz, achieves a total gain of −2.8 dB at the back broadside, a 6 dB back-to-front ratio, and 1.5 dB beamwidth of ±60°.

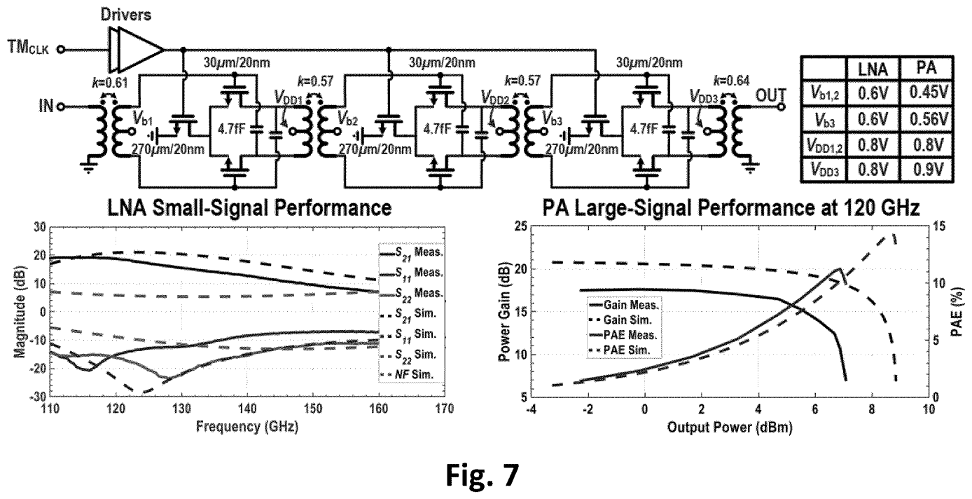

FIG. 7 shows a 3-stage frontend amplifier with capacitively neutralized common-source stages and transformer matching networks. The same amplifier can be reused as the LNA and the PA with different biasing. In the LNA mode, the 3-stage amplifier achieves a measured gain of 19 dB at 120 GHz, a 10-dB input matching bandwidth across 110-136 GHz, and the measured output matching is <−10 dB across the whole D-band. The simulated NF is 5.8 dB at 120 GHz. In the PA mode, at 120GHz, the 3-stage amplifier achieves a measured gain of 17.6 dB, a P1dB of 4.7 dBm, a Psat of 6.8 dBm, and a PAEmax of 11.3%.

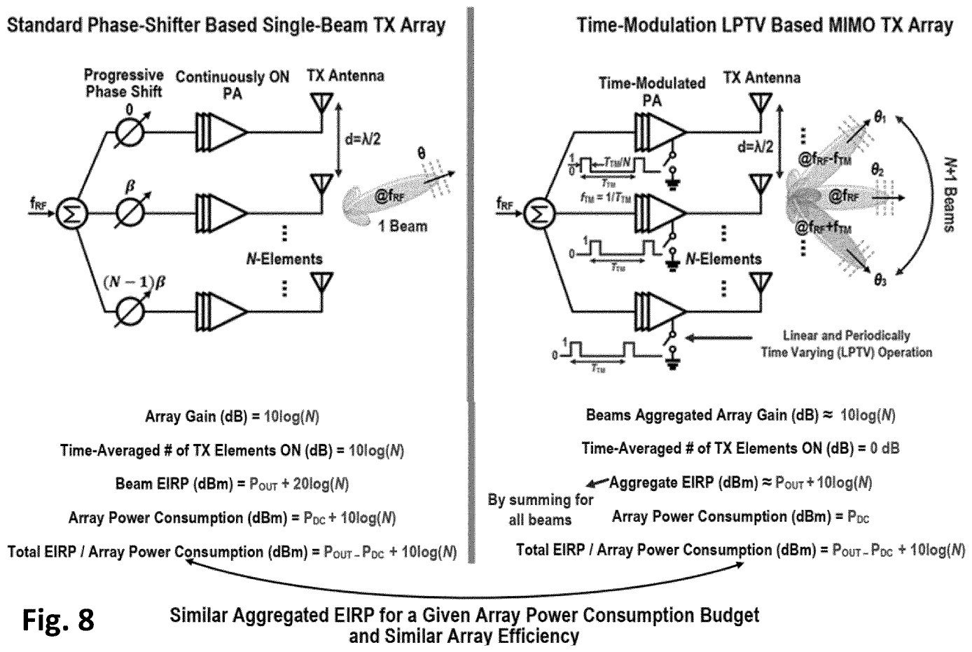

FIG. 8 shows that compared with state-of-the art relays, a time-modulated active relay according to the present invention achieves a competitive performance at high mm-wave frequency (e.g. 120 GHz). In particular, a standard phase-shifter based single-beam TX array and a time-modulation LPTV based MIMO TX array have a similar aggregated effective-isotropic-radiated-power (EIRP) for a given array power consumption budget and similar array efficiency.

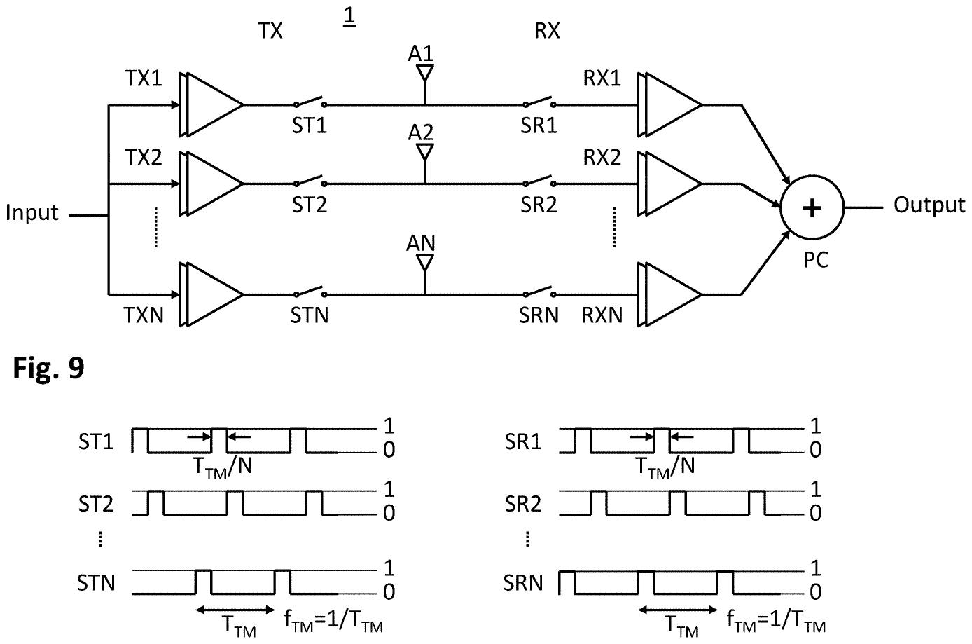

FIG. 9 shows a circuit diagram of an exemplary electronic device 1 according to the present invention enabling full-duplex communication. A time-modulated transmitter array TX as described above is connected to a time-modulated receiver array RX as described above, wherein the transmitter array TX and the receiver array RX share the same antenna elements A1, . . . , AN. As shown in FIG. 9, the switches ST1, . . . , STN of the transmitter array TX and the switches SR1, . . . , SRN operate in an interleaved fashion, such that an antenna element An, n=1, . . . , N, is connected either to the respective transmitter TXn of the transmitter array TX or to the respective receiver RXn of the receiver array RX. By the virtue of the time-interleaved operation, full-duplex capability and perfect inherent interference cancellation are achieved.

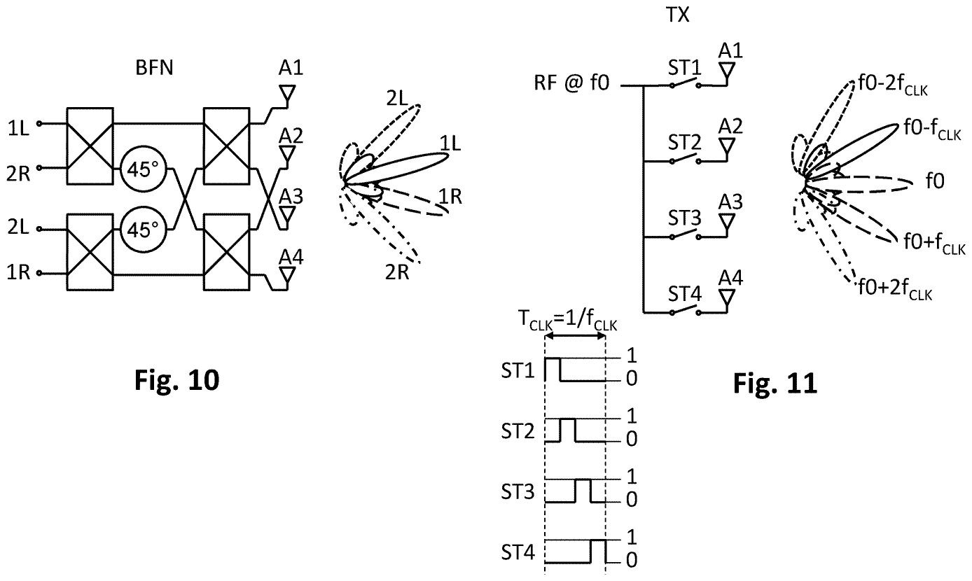

FIG. 10 shows a circuit diagram of an exemplary beamforming network BFN. An N-element beamforming network BFN with 90° hybrid couplers and 45° phase shifters realizes a passive static beamformer. For the example of N=4, four inputs (2L, 1L, 1R, and 2R) are distributed to four antennas A1, . . . , A4 with appropriate phase shifts and uniform amplitudes through the 4×4 beamforming network BFN, yielding four beams with four independent streams at ±15° and ±49° radiation angles. Moreover, an extended N-element passive beamforming network BFN generates concurrent N-beams in N different directions based on N inputs (streams), yet at the expense of an area of the beamforming network BFN and passive losses.

FIG. 11 shows a circuit diagram of an exemplary time-modulated transmitter array TX. The transmitter array TX includes N TX paths. Each TX includes a switch Sn, which is connecte to an antenna element ATn, n=1, . . . , N (FIG. 11 shows an example with four switches ST1, . . . , ST4). Each switch S1, . . . , SN is connected to an input signal RF having frequency f0. A phase shifter can be added after the time-modulated switches ST1, . . . , STN in FIG. 11. The use of the explicit phase shifter allows to steer the TX output beam.

As shown in FIG. 11, the switches ST1, . . . , STN are switched between on (indicated with state 1) and off (indicated with state 0, cf. timing diagram of FIG. 11). Namely, a first switch ST1 is turned on during a first period of time and the other switches are turned off, a second switch ST2 is turn on during a second period of time and the other switches are turned off, etc. Accordingly, the switches ST1, . . . , STN enable time-modulation of the transmitter array TX.

As shown in FIG. 11, the time-modulated transmitter TX enables N+1 concurrent multi-beams at N+1 different angels at distinct frequencies with a spectral-to-spatial mapping.

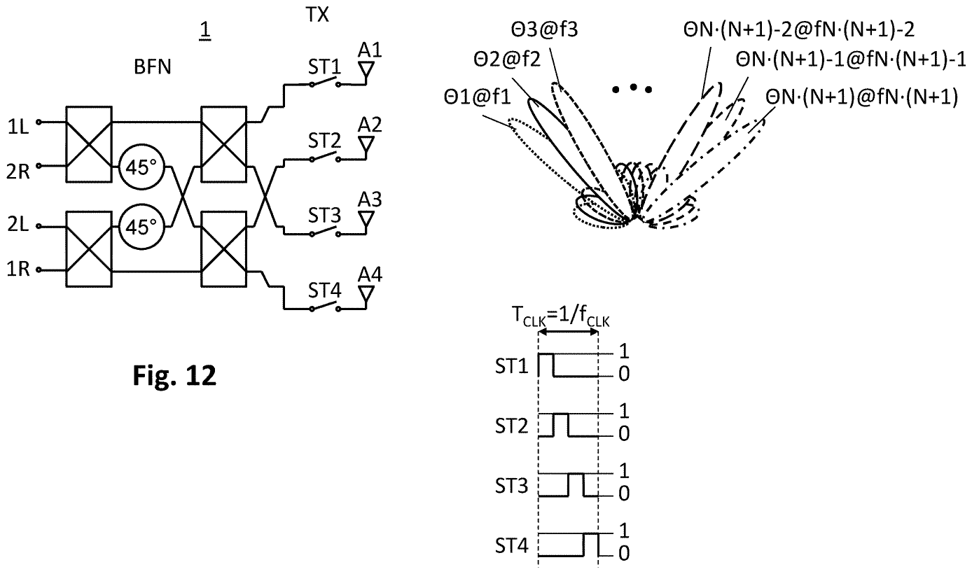

FIG. 12 shows a circuit diagram of an exemplary electronic device 1 according to the present invention enabling beam multiplication. A N-element beamforming network BFN (as an example, FIG. 12 shows a 4-element beamforming network BFN) is followed by a N-element time-modulated transmitter array TX (as an example, FIG. 12 show a 4-element time-modulated transmitter array TX). Each output of the beamforming network BFN is connected to a switch STn, n=1, . . . , N, of the time-modulated transmitter array TX. As shown in FIG. 12, the electronic device 1 transmits N·(N+1) concurrent beams and has a unique beam multiplication effect. The generalized architecture can also be viewed as applying spacetime modulation on classic static multi-beam beamformers to produce a large number of beams at distinct frequencies with few array elements. For concurrent 20-beam generation, the beamformer according to the present invention only requires a 4-element TX array, massively reducing hardware complexity, power consumption, and costs.

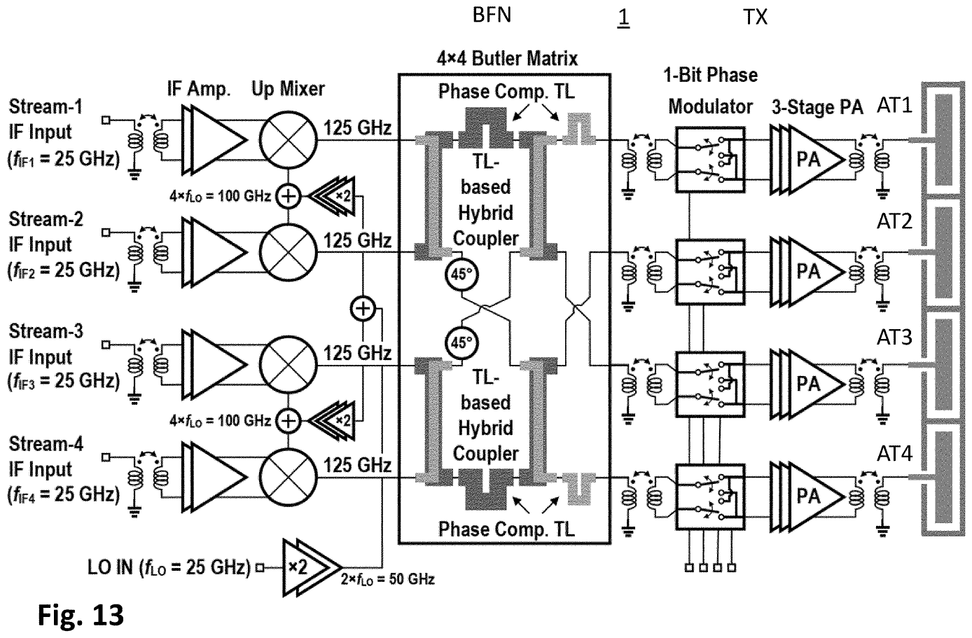

FIG. 13 shows a circuit diagram of an exemplary electronic device 1 according to the present invention, in particular the schematic and block diagram of a 4-element beamforming circuit. Each 25 GHz input signal (IF1-to-IF4 as four independent streams) is up-converted through a 2-stage amplifier and an up-conversion passive mixer with a 100 GHz local oscillator LO signal. The resulting 125 GHz output signal is fed to the 4×4 fully passive beamforming network BFN (4×4 Butler Matrix) implemented using on-chip transmission lines. Each output signal of the beamforming network BFN is modulated by a 1-bit (0°/180°) phase modulator for phase-modulation (PM) based time-modulated transmitter array TX operation, which includes a 3-stage power amplifier (PA) and radiates through on-chip folded slot antennas AT1, . . . , AT4. The implementation of the phase-modulation based time-modulated transmitter can be done using multiples phases such as 0°/90°/180°/270°. The local oscillator LO generation network employs two cascaded frequency doubler and amplifier chains to provide a 100 GHz LO signal for the up-conversion mixers.

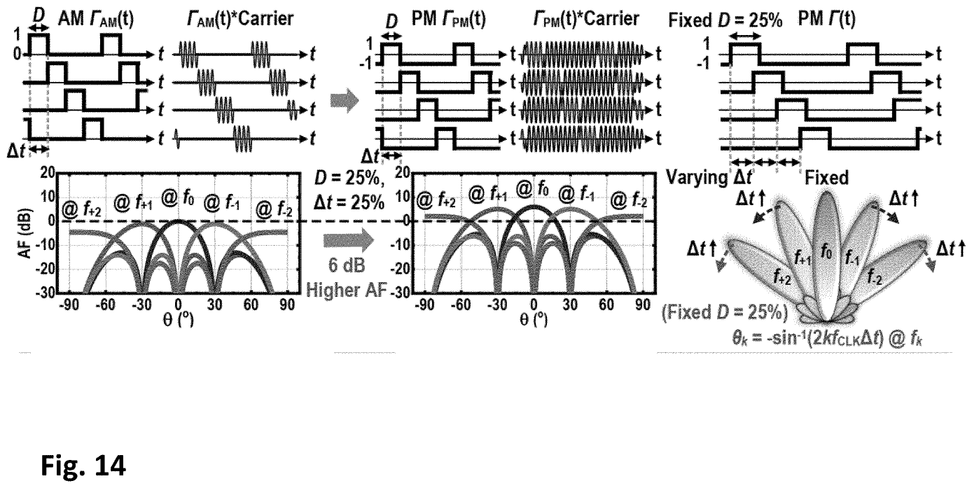

FIG. 14 shows an amplitude modulation AM scheme and a phase modulation PM scheme. Standard time-modulated transmitter arrays TX are often implemented in amplitude modulation AM schemes. For example, four switches are driven by 4-phase equally-spaced non-overlapping clocks with a duty-cycle D of 25% and a time offset At of 25%, which directly modulate the carrier amplitude. Consequently, the 4-element AM-based time-modulated transmitter array TX allows the generation of the concurrent five beams projecting θ of ±90°, ±30°, and 0° at fc+nf_{TMA} (n=±2, ±1, 0), respectively. However, the AM-based time-modulated transmitter array TX incurs inherently reduced radiated output power and lower EIRP, due to its OFF-state operation, resulting in a maximum array factor AF only at unity (AF=0 dB). To boost the AF, according to an embodiment of the invention, a phase modulated PM-based time-modulated transmitter array TX technique utilizes a 1-bit (0°/180°) phase modulator. By allowing all the TX elements to be ON throughout the entire operation, the PM-based time-modulated transmitter array TX recovers the total radiated power/EIRP and achieves a 6 dB higher array factor AF than the AM-based time-modulated transmitter array TX, while the PM-based time-modulated transmitter array realizes the same concurrent multi-beam generation as the AM-based time-modulated transmitter array TX. Note the time-modulated transmitter array TX also offers beam angle control without any explicit power/area-hungry RF phase shifters. Instead of using phase shifters, the steering angles of each beam can be varied by adjusting the Δt of the time-modulated transmitter array TX clock sequence (cf. FIG. 14 top right). The beam angle can be steered using Δt variation in time sequences together with or without phase shifters. As Δt increases, the boresight beam at fc maintains its angle of 0°, while the angles of the remaining four beams at fc+nf_{TMA} (n=±2, ±1) symmetrically shift towards the end-fire direction. In the joint beamformer according to the present invention, although the beam angles from the static beamformer network BFN are fixed, the dynamic time-modulated transmitter array TX allows casting concurrent 20-beam with beam angle steering across full field-of-view (FoV) by its unique and reconfigurable spectral-to-spatial mapping, which enables rapid one-shot localization and fast situation awareness sensing applications. Additionally, the time sequences can be re-programmable such that the number of concurrent beams/nulls can be controllable.

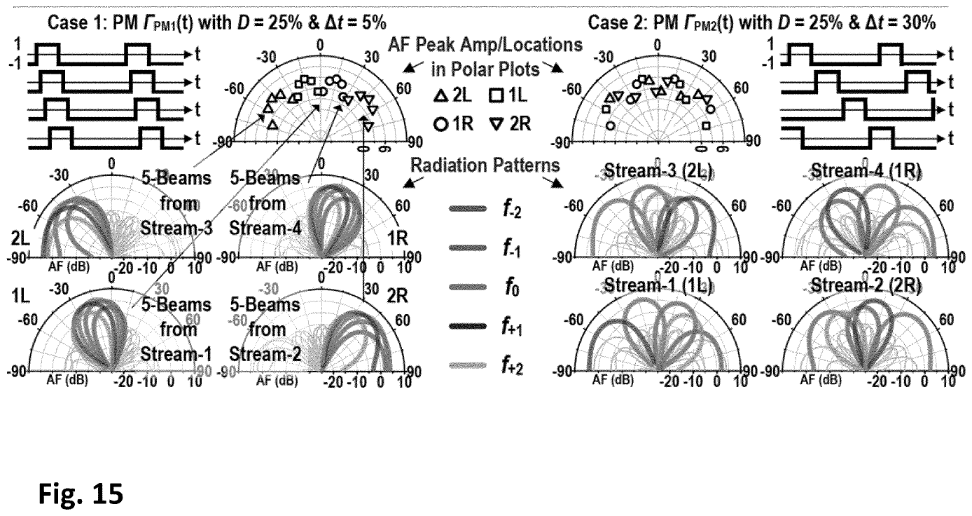

FIG. 15 shows clock scenarios for spatial distribution of concurrent 20 beams. To uniformly distribute 20-beam across −60°-to-60°in space, Δt can be chosen as either 5% or 30% while keeping D of 25%. Although time-overlapping time-modulation sequences result in spatial overlapping for some beams, all the time-modulated transmitter array TX beams are at different carrier frequencies and thus easily distinguishable. To realize the PM-based time-modulated transmitter array TX, a 1-bit 0°/180° phase modulator is placed prior to the 3-stage PA (power amplifier).

Unlike A. Nagulu, et al. that achieves the full-duplex functionality with sophisticated circuitry to reduce the transmitter-receiver interference, an exemplary embodiment of the electronic device 1 according to the present invention has a perfectly inherent interference cancellation by the virtue of the time-interleaved operation. In addition, the work reported in A. Nagulu, et al. does not provide MIMO capability, unlike the present invention that combines full-duplex and MIMO capabilities. The proposed multi-beam MIMO TX and/or RX can be used not only for communication applications but also for sensing applications such as MIMO radar system and cognitive radar with a trade-off of scanning speed, sensing depth, and resolution.

E. Naviasky, et al. provides a means to achieve the MIMO capability relying on sophisticated digital signal processing. Compared to an exemplary embodiment of the electronic device 1 according to the present invention, E. Naviasky, et al. does not have full-duplex capability and the MIMO capability is only implemented at the receiver side.

Compared to the state-of-the-art, the proposed invention can simultaneously achieve both MIMO and full-duplex capabilities with inherent transmitter-receiver cancellation.

In Sadhu, Bodhisatwa, et al., the concurrent multi-beam is generated by dividing the whole antenna array into several sub-arrays (1×M) where each sub-array creates a single-beam. Compared to the present invention, the number of available beams in this architecture is the same as that of the sub-arrays, which limits the massive beam generation. Besides, this architecture requires the dedicated phase shift for each antenna array. For achieving the massive beam generation, the resolution of the phase shifter needs to be substantially precise.

Compared to the state-of-the-art, an exemplary embodiment of the electronic device 1 according to the present invention enables concurrent multi-beam and allows to take advantages of the reduced number of elements and the elimination of the additional phase shifter.

Embodiments of the electronic device 1 according to the present invention can be applied to many commercial products including radar transceivers, imaging, spectrometers, wireless communication transceivers for mobile devices, basestations, satellite, AR/VR, advanced manufacturing, etc.

Finally, it should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

1. An electronic device, comprising:
a time-modulated receiver array or a beamforming network connected with a time-modulated transmitter array, wherein the time-modulated transmitter array includes a plurality of switches which are periodically operable between an on state and an off state for periodic signal transmission to a plurality of antenna elements.

2. The electronic device according to claim 1, wherein the switches of the time-modulated transmitter array are operable in an non-overlapping mode.

3. The electronic device according to claim 1, wherein a power splitter of the time-modulated transmitter array is connected to a power combiner of the time-modulated receiver array.

4. The electronic device according to claim 1, wherein antenna elements are shared by the time-modulated receiver array and the time-modulated transmitter array.

5. The electronic device according to claim 4, wherein switches of the time-modulated receiver array and switches of the time-modulated transmitter array are operable in a time-interleaved mode.

6. The electronic device according to claim 1, wherein the beamforming network includes one or more of a passive beamformer, an active beamformer, a Butler matrix, a Rotman Lens, a phase-shifter based beamformer, an analog beamformer, a digital beamformer, and a hybrid beamformer.

7. The electronic device according to claim 1, wherein the time-modulated transmitter array includes one or more of an amplitude modulation circuit and a phase modulation circuit.

8. The electronic device according to claim 1, wherein one or more switches is operable in a signal path or in a biasing path.

9. The electronic device according claim 1, wherein one or more switches is further connected to a phase shifter.

10. The electronic device according to claim 1, operable at a 0/180 switching scheme or a multiphase switching scheme.

11. A radar system comprising:
an electronic device comprising a time-modulated receiver array or a beamforming network connected with a time-modulated transmitter array, wherein the time-modulated transmitter array includes a plurality of switches which are periodically operable between an on state and an off state for periodic signal transmission to a plurality of antenna elements.

12. A method of operating an electronic device, the method comprising:
providing a time-modulated receiver array or a beamforming network connected with a time-modulated transmitter array, wherein the time-modulated transmitter array includes a plurality of switches; and
periodically operating the switches between an on state and an off state for periodic signal transmission to the plurality of antenna elements.

13. The method according to claim 12, wherein the switches of the time-modulated transmitter array are operated in an non-overlapping mode.

14. The method according to claim 12, wherein the electronic device is operated for sharing antenna elements between the time-modulated receiver array and the time-modulated transmitter array.

15. The method according to claim 12, wherein the plurality switches are operated in a time-interleaved mode.

16. The method according to claim 12, wherein one or more switches is operated in a signal path or in a biasing path.

17. The method according to claim 12, wherein the electronic device is operated at a 0/180 switching scheme or a multiphase switching scheme.
